(19) United States
(12) Patent Application Publication
(10) Pub. No.: US 2013/0108206 A1
(43) Pub. Date: May 2, 2013

(54) POLARIZATION MAINTAINING MULTI-CORE OPTICAL FIBER

(71) Applicant: SUMITOMO ELECTRIC INDUSTRIES, LTD., Osaka (JP)

(72) Inventors: Eisuke Sasaoka, Yokohama-shi (JP); Hiroo Kanamori, Yokohama-shi (JP)

(73) Assignee: SUMITOMO ELECTRIC INDUSTRIES, LTD., Osaka (JP)

(21) Appl. No.: 13/633,500

(22) Filed: Oct. 2, 2012

Related U.S. Application Data
(60) Provisional application No. 61/657,149, filed on Jun. 8, 2012.

(30) Foreign Application Priority Data
Oct. 4, 2011 (JP) 2011-220328

(51) Int. Cl. G02B 6/02

(52) U.S. Cl. CPC G02B 6/02042
USPC 385/11

(57) ABSTRACT

In a polarization maintaining multi-core optical fiber according to the present invention, structural birefringence is generated since an elliptic core is applied. In addition, each core is arranged so that a direction of a line connecting between centers of the nearest cores and a long axis direction of a field distribution in each core may be different from each other, and thereby, overlap of field distributions between the nearest cores is reduced. As a result, a crosstalk among cores is reduced.

### BACKGROUND OF THE INVENTION

1. Field of the Invention

The present invention relates to a polarization maintaining multi-core optical fiber.

2. Related Background of the Invention

Known is a polarization maintaining multi-core optical fiber which has a structure where while a plurality of cores is provided in a cladding, an intermediate layer (a stress-applying layer and/or a hole) for causing a birefringence in the cores is provided among the cores, and in which this intermediate layer is shared by a plurality of cores (refer to Japanese Patent Application Laid-Open No. 62-178909 (Patent Document 1), for example).

### SUMMARY OF THE INVENTION

The present inventors have examined the above-described conventional polarization maintaining multi-core optical fiber, and as a result, have discovered the following problems.

That is, in the polarization maintaining multi-core optical fiber of Patent Document 1 described above, there has been a problem that fiber diameter reduction cannot be performed sufficiently. The reason is that for causing a birefringence in a core, it is necessary to secure a stress-applying part which is sufficiently larger than the core and that there is a possibility that a size of this stress-applying part poses a problem for high-density arrangement of cores and fiber diameter reduction. In addition, generation of a crosstalk among cores has been often a problem in the past in a multi-core optical fiber, but in the polarization maintaining multi-core optical fiber according to Patent Document 1 described above, investigation on the crosstalk among cores has not been performed. Therefore, in the conventional polarization maintaining multi-core optical fiber, there has been a possibility that suppression of the crosstalk among cores is insufficient.

The present invention has been developed to eliminate the problems described above. It is an object of the present invention to provide a polarization maintaining multi-core optical fiber which achieves the high-density arrangement of cores and the fiber diameter reduction, and where the crosstalk among cores is suppressed.

A polarization maintaining multi-core optical fiber according to the present invention comprises a plurality of cores in the same cladding. In order to achieve the above-described object, the polarization maintaining multi-core optical fiber according to a first aspect has a polarization maintaining characteristic which results from structural asymmetry of each of a plurality of cores or structural asymmetry in the vicinity each of the plurality of cores. In addition, in the polarization maintaining multi-core optical fiber according to the first aspect, a field distribution of light in each of the plurality of cores is asymmetric. Furthermore, in the polarization maintaining multi-core optical fiber according to the first aspect, a direction of a straight line connecting between a center of an arbitrary core among the plurality of cores and a center of the core nearest to the arbitrary core is different from a long axis direction of the field distribution of light in the arbitrary core.

In accordance with the polarization maintaining multi-core optical fiber according to the first aspect, structural birefringence is generated resulting from structural asymmetry of each core or structural asymmetry in the vicinity of each core in a cladding, and thereby, when a linearly polarized light is made incident, it becomes possible to make it propagate with the polarization state maintained. Therefore, a stress-applying part or the like which is required in a general polarization maintaining multi-core optical fiber becomes unnecessary, and it becomes possible to arrange cores within a definite cladding cross-section area with higher density. In addition, the direction of the straight line connecting between the center of the arbitrary core and the center of the core nearest to the arbitrary core is different from a long axis direction of the field distribution of light in the arbitrary core. Thereby, between the arbitrary core and the nearest core, overlap of field distribution is reduced. As a result, in comparison with the case where the direction of the line connecting between the centers of the nearest cores and the long axis direction of the field distribution of light in each core are in agreement, the crosstalk among cores is reduced effectively.

As a specific configuration (a second aspect applicable to the first aspect) which exerts the above-described effect effectively, specifically, regarding a diameter of the arbitrary core, a diameter (first core diameter) of the arbitrary core along a long axis direction of the field distribution of light in the arbitrary core is different from a diameter (second core diameter) of the arbitrary core along a short axis direction of the field distribution of light in the arbitrary core. In addition, as a third aspect applicable to at least one of the first and second aspects, the arbitrary core among the plurality of cores is an elliptic core. The structural birefringence is generated by making a core shape as an ellipse, and it becomes possible to carry out polarization maintaining without providing a stress-applying part. Therefore, it becomes possible to arrange cores with high density, in a state where a crosstalk among cores is suppressed.

In addition, as a specific configuration (a fourth aspect applicable to at least any one of the first to third aspects) which exerts the above-described effect effectively, specifically, a pair of holes arranged so as to sandwich the arbitrary core among the plurality of cores are provided. Also in the case of the configuration where the pair of holes are provided as described above, birefringence is generated by the holes. Therefore, it becomes possible to carry out polarization maintaining without providing a stress-applying part, and it becomes possible to arrange cores with high density, in a state where a crosstalk among cores is suppressed.

### BRIEF DESCRIPTION OF THE DRAWINGS

FIG. 1 is a schematic sectional view for illustrating a configuration of a polarization maintaining multi-core optical fiber according to a first embodiment;

FIG. 2 is a schematic sectional view for illustrating a modification example of the polarization maintaining multi-core optical fiber according to the first embodiment;

FIG. 3 is a schematic sectional view for illustrating a configuration of a polarization maintaining multi-core optical fiber according to a second embodiment;

FIG. 4 is a schematic sectional view for illustrating a configuration of a polarization maintaining multi-core optical fiber according to a third embodiment;

FIG. 5 is a schematic sectional view for illustrating a configuration of a polarization maintaining multi-core optical fiber according to a fourth embodiment;

FIG. 6 is a schematic sectional view for illustrating a modification example of a polarization maintaining multi-core optical fiber according to the fourth embodiment;

FIG. 7 is a schematic sectional view for illustrating a configuration of a polarization maintaining multi-core optical fiber according to a fifth embodiment;

FIG. 8 is a schematic sectional view for illustrating a configuration of a polarization maintaining multi-core optical fiber according to a sixth embodiment; and

FIG. 9 is a schematic sectional view for illustrating a configuration of a polarization maintaining multi-core optical fiber according to a seventh embodiment.

### DESCRIPTION OF THE PREFERRED EMBODIMENTS

In the following, with reference to accompanying drawings, embodiments for carrying out the present invention will be described in detail. Besides, in description of drawings, the same symbol is given to the same component, and overlapped description is omitted.

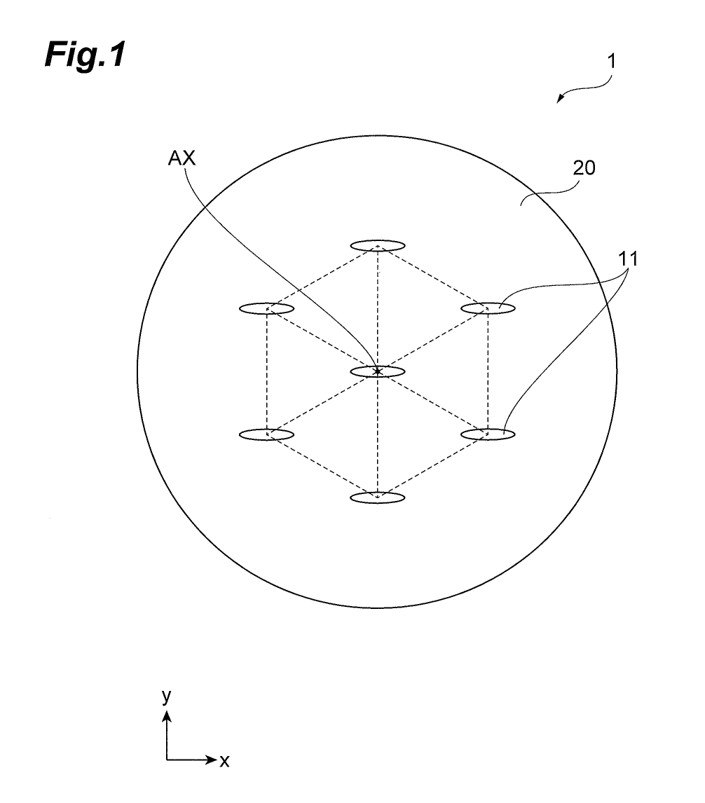

Embodiments in the following will be described using a schematic sectional view of a polarization maintaining multi-core optical fiber. The polarization maintaining multi-core optical fiber has a structure provided with a plurality of cores each of which has a shape extending along a central axis AX and is composed of silica glass, and a cladding which is provided on the outer peripheries of these plural cores and is composed of silica glass. In FIGS. 1 to 9 in the following, shown is a cross section in which the cores of the polarization maintaining multi-core optical fiber extend, and which is perpendicular to the direction in which the polarization maintaining multi-core optical fiber extends along the central axis AX. In addition, as a matter of convenience of explanation of an arrangement of cores in the multi-core optical fiber, an x-axis (horizontal direction in the drawing) and a y-axis (vertical direction in the drawing) which are mutually orthogonal are indicated, and description will be given using these.

### First Embodiment

FIG. 1 is a schematic sectional view for showing a configuration of the polarization maintaining multi-core optical fiber according to a first embodiment of the present invention.

In a polarization maintaining multi-core optical fiber 1 according to the first embodiment, seven elliptic cores 11 each having an elliptic shape are provided in a cladding 20 via a part of the cladding 20. These seven elliptic cores 11 are arranged so that each center may correspond to a triangular lattice point. More specifically, the center core of the seven elliptic cores 11 is provided at the position where the center thereof becomes the center of the multi-core optical fiber 1, and is the nearest to six peripheral cores. Two cores among the six peripheral cores are arranged along the y-axis direction at the position which is in alignment with the center core, and each of four remaining cores or each of peripheral cores becomes the nearest to the peripheral cores adjacent thereto and the center core. Thereby, a line connecting between the centers of the nearest elliptic cores 11 (dashed line in FIG. 1) forms one side of the triangular lattice. In the multi-core optical fiber 1 of FIG. 1, four lines connecting between the nearest cores exist along the y-axis direction, and the other eight lines extend in different directions from the x-axis and y-axis.

In addition, in the seven elliptic cores 11, since a light field distribution expands more in the long axis direction rather than in the short axis direction of the ellipse, the long axis of the ellipse and the long axis of the field distribution are generally in agreement. In the polarization maintaining multi-core optical fiber 1 of FIG. 1, each elliptic core 11 is arranged so that the long axis of the ellipse in the elliptic core 11 may be in the x-axis direction. Because there is no line extending in the x-axis direction among the lines connecting the nearest cores, the direction of the line, shown by a dashed line, connecting between the centers of the nearest cores differs, in FIG. 1, from the long axis direction (that is, long axis direction in the elliptic core) of the field distribution. At this time, an angle between a line connecting between the centers of the nearest cores and the long axis of the field distribution is made to be the maximum of 90 degrees and the minimum of 30 degrees.

The polarization maintaining multi-core optical fiber 1 is manufactured by means of the following methods, for example. That is, holes having the sectional shape of an ellipse are provided in a cladding member in accordance with the number of cores, and thereafter, a core member having the sectional shape of an ellipse is inserted into each hole, and thereafter, the integration into one piece is carried out to give a preform. Then, by drawing the preform, the polarization maintaining multi-core optical fiber is acquired. In addition, as other methods, the following methods are included. That is, while holes having the sectional shape of a circle are provided in a cladding member in accordance with the number of cores, holes having the sectional shape of a circle are opened so as to sandwich the circular hole adjacently (this hole is provided along the long axis direction of the elliptic core). Then, when inserting into the hole for a core a core member having the sectional shape of a circle, and carrying out heating and integration, by crushing the holes located at both sides of the hole into which the core member has been inserted, a preform where the core sectional shape is made to be an ellipse is formed, and thereafter, by drawing the preform, the polarization maintaining multi-core optical fiber is acquired.

As the polarization maintaining multi-core optical fiber 1 according to the present embodiment, for example, a diameter of the cladding 20 is made to be 125 μm, a length of the long axis of the elliptic core 11 is made to be 10 μm, a length of the short axis is made to be 2 μm, a relative refractive index difference between a core and a cladding is made to be 1.0% and a distance between the centers of the nearest cores is made to be 30 μm.

Here, in the polarization maintaining multi-core optical fiber of the present embodiment, by ovalizing a core, structural birefringence is generated. In addition, generated is also stress birefringence generated when cooling after heating in a fiber drawing process due to a difference of thermal expansion coefficients between each core and the cladding of the polarization maintaining multi-core optical fiber. Therefore, for each core included in the polarization maintaining multi-core optical fiber, if a linearly polarized wave in agreement with the polarization main axis direction is made incident, it becomes possible to make it propagate with the polarization state maintained. In addition, in the polarization maintaining multi-core optical fiber 1 according to the present embodiment, because birefringence is made to be generated by ovalizing a core, a stress-applying part or the like which is required in a general polarization maintaining multi-core optical fiber becomes unnecessary. Therefore, it becomes possible to arrange cores within a definite cladding cross-section area with high density. In addition, the direction of the line connecting between the centers of the nearest cores and the long axis direction of the field distribution (that is, the long axis direction in the elliptic core) are made to be different from each other, and thereby, overlap of field distributions between the nearest cores is reduced, and therefore, in comparison with the case where the direction of the line connecting between the centers of the nearest cores and the long axis direction of the field distribution are in agreement, the crosstalk among cores is reduced.

Moreover, as for the elliptic core 11 included in the polarization maintaining multi-core optical fiber 1, all the long axis directions of the field distribution of light are in agreement. With such configuration, it is not necessary to adjust individually the polarization main axis direction at the time of coupling the multi-core optical fiber with other devices, and thus the handling becomes easy.

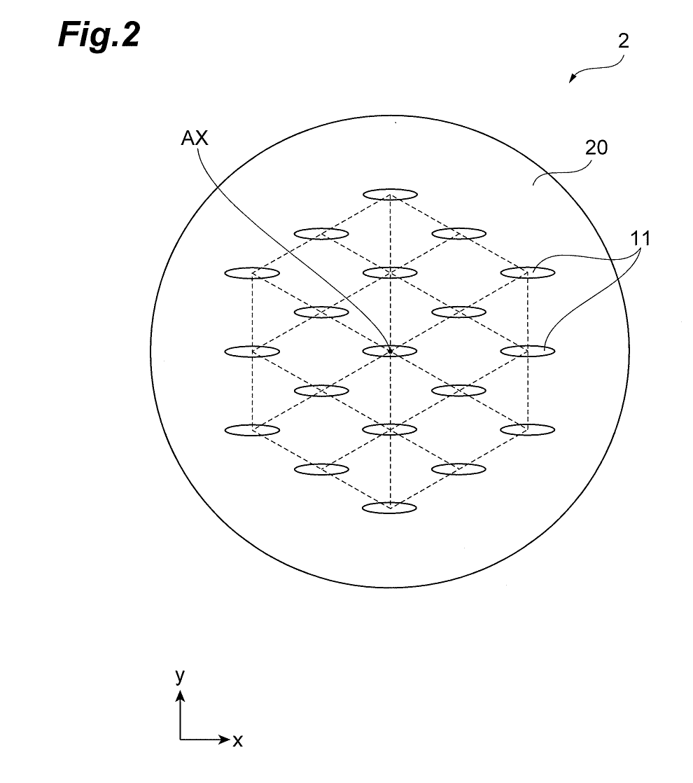

Besides, in FIG. 2, as a modification example of the first embodiment, shown is a polarization maintaining multi-core optical fiber 2 where 19 elliptic cores 11 are arranged. Also in the polarization maintaining multi-core optical fiber 2, in the same way as the polarization maintaining multi-core optical fiber 1, the line connecting between the nearest cores has extended in the y-axis direction or in the direction where the angle formed with the y-axis will be 60 degrees, and the elliptic cores 11 are arranged so that the long axis direction may be along the x-axis. As an example of the polarization maintaining multi-core optical fiber 2, when the crosstalk among cores is made to be comparable as the polarization maintaining multi-core optical fiber 1, a diameter of the cladding 20 is 180 μm, a length of the long axis of the elliptic core 11 is 10 μm, a length of the short axis is 2 μm, a relative refractive index difference between a core and a cladding is 1.0%, and a distance between the centers of the nearest cores is 30 μm. In addition, when giving priority to proximate arrangement of cores (high-density), a diameter of the cladding 20 can be made to be 125 μm, a length of the long axis of the elliptic core 11 can be made to be 10 μm, a length of the short axis can be made to be 2 μm, a relative refractive index difference between a core and a cladding can be made to be 1.0%, and a distance between the centers of the nearest cores can be made to be 15 μm. In this manner, the polarization maintaining multi-core optical fiber of the present embodiment is the multi-core optical fiber capable of making the linearly polarized wave propagate with the polarization state maintained, and can exert an effect that cores are arranged with high density and the crosstalk among cores is reduced.

### Second Embodiment

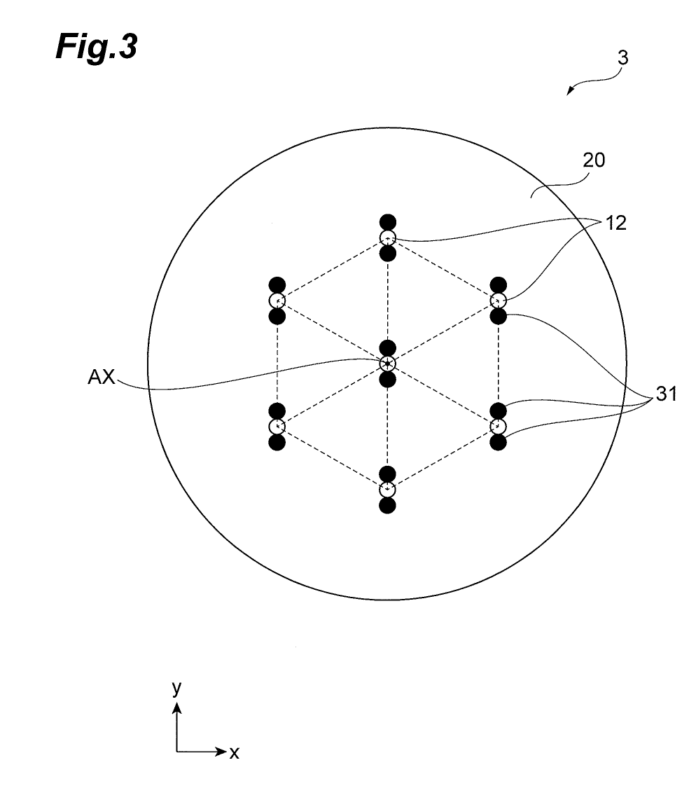

FIG. 3 is a schematic sectional view for showing a configuration of a polarization maintaining multi-core optical fiber according to a second embodiment of the present invention.

In a polarization maintaining multi-core optical fiber 3 according to the second embodiment, in the same way as the polarization maintaining multi-core optical fiber 1 according to the first embodiment, seven circular cores 12 are arranged so that the centers thereof may form triangular lattice points. Arrangement of circular cores 12 is the same as the arrangement of the elliptic cores 12 of the polarization maintaining multi-core optical fiber 1 according to the first embodiment, and the line connecting between the nearest cores has extended in the y-axis direction or in the direction where the angle formed with the y-axis will be 60 degrees. Then, at both sides of each circular core 12, one pair of side tunnels 31 which are made up of holes is provided. The side tunnel 31 and the circular core 12 are provided so that it may be located on a straight line in the y-axis direction. In the circular core 12 sandwiched by one pair of the side tunnels 31, the long axis of the field distribution is orthogonal to the direction of the side tunnel 31. This is because due to large refractive index difference between the core and the side tunnel, light confinement on the side of the side tunnel becomes strong, and relatively, the field distribution of light expands more in the direction orthogonal thereto. Consequently, in the case of the polarization maintaining multi-core optical fiber 3 shown in FIG. 3, an angle between each dashed line and the long axis of the field distribution is made to be the maximum of 90 degrees and the minimum of 30 degrees.

The polarization maintaining multi-core optical fiber 3 is manufactured by the following methods, for example. Specifically, while holes for cores having a sectional shape of a circle are provided in a cladding member in accordance with the number of cores, holes for side tunnels having a sectional shape of a circle are provided also in the both sides thereof. After that, after inserting the core members each having a sectional shape of a circle into the holes for cores, the integration into one piece is carried out to give a preform. Then, by drawing the preform, the polarization maintaining multi-core optical fiber is acquired. Here, by pressurizing or the like the inside of the holes for the side tunnels in the both sides of the cores in the drawing, the polarization maintaining multi-core optical fiber with the side tunnels formed can be acquired. In addition, as another method, a method can be used where a rod depending on a material of a cladding member and a core member is prepared, and a hollow pipe is prepared at the position where a side tunnel is to be formed, and a preform for the multi-core optical fiber is prepared by so-called a stack & draw method, and then drawing the preform is made to be carried out.

As the polarization maintaining multi-core optical fiber 3 according to the present embodiment, for example, a diameter of the cladding 20 is made to be 125 μm, a diameter of the circular core 12 is made to be 8 μm, a diameter of the side tunnel 31 is made to be 10 μm, a center distance between the circular core 12 and the side tunnel 31 is made to be 9 μm, a relative refractive index difference between the core and the cladding is made to be 0.4%, and a distance between the centers of the nearest cores is made to be 35 μm.

Here, in the polarization maintaining multi-core optical fiber 3 according to the present embodiment, resulting from the side tunnel 31 being provided on both sides of the circular core 12, the structural birefringence is generated. Therefore, with respect to each core included in the multi-core optical fiber, if a linearly polarized wave in agreement with a polarization main axis direction is made incident, it becomes possible to make it propagate with the polarization state maintained. In addition, when a configuration of generating the birefringence by the side tunnel 31, it is possible to generate polarization maintaining performance by the side tunnel more small-sized than the stress-applying part. Therefore, it becomes possible to arrange cores within a definite cladding cross-section area with high density. Moreover, the direction of the line connecting between the centers of the nearest cores and the long axis direction of the field distribution (that is, the direction orthogonal to the direction in which the side tunnel is provided) are made to be different from each other, and thereby, overlap of field distributions between the nearest cores is reduced, and therefore, in comparison with the case where the direction of the line connecting between the centers of the nearest cores and the long axis direction of the field distribution are in agreement, the crosstalk among cores is reduced.

### Third Embodiment

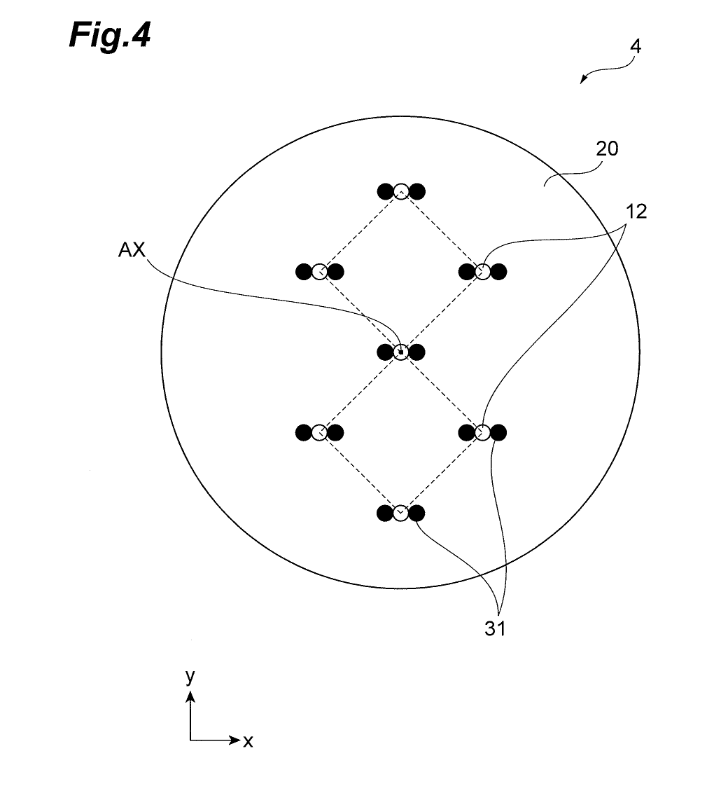

FIG. 4 is a schematic sectional view for showing a configuration of a polarization maintaining multi-core optical fiber according to a third embodiment of the present invention.

In the polarization maintaining multi-core optical fiber 3 described in the second embodiment, the side tunnel 31 has been arranged in the y-axis direction as shown in FIG. 3, but if this is arranged in the x-axis direction, a combination where the direction of the line connecting between the centers of the nearest cores and the long axis direction of the field distribution will have been in agreement will be generated in some cores (a case where cores which are adjacent in the y-axis direction are the nearest to each other), and as a result, an increase of the crosstalk among cores will be cared. As a method to solve this, considered is a method where the center distance of cores which are adjacent in the y-axis direction is made to be enlarged, and these cores are made not to be the nearest cores.

In a polarization maintaining multi-core optical fiber 4 according to the third embodiment, the arrangement of seven circular cores 12 in the polarization maintaining multi-core optical fiber 3 is made to be changed from the triangular lattice shape, and has been extended in the y-axis direction as compared with FIG. 3. Dashed lines connecting between the nearest cores are decreased from 12 (FIGS. 3) to 8 in number, and the circular cores 12 which are adjacent in the y-axis direction are not the nearest cores. Consequently, the lines which connect between the centers of the nearest core and extend in the y-axis direction have disappeared. In addition, an area surrounded by four dashed lines connecting between the nearest cores is made to have a rhombus shape where the x-axis direction corresponds to a short axis, and the y-axis direction corresponds to a long axis. As a result, even when the side tunnels 31 are made to be arranged in the x-axis direction as shown, it is considered that a crosstalk among cores in the cores located in a line in the y-axis direction as shown is reduced.

As the polarization maintaining multi-core optical fiber 4 according to the present embodiment, for example, a diameter of the cladding 20 is made to be 125 μm, a diameter of the circular core 12 is made to be 8 μm, a diameter of the side tunnel 31 is made to be 10 μm, a center distance between the circular core 12 and the side tunnel 31 is made to be 9 μm, a relative refractive index difference between a core and a cladding is made to be 0.4%, a distance between the centers of the nearest cores is made to be 30 μm, a center distance of the cores which are adjacent in the y-axis direction is made to be 50 μm, and a center distance of the cores which are adjacent in the x-axis direction is made to be 33.2 μm. In this case, an angle between the line connecting the centers of the nearest cores and the long axis of the field distribution will be 33.6 degrees.

### Fourth Embodiment

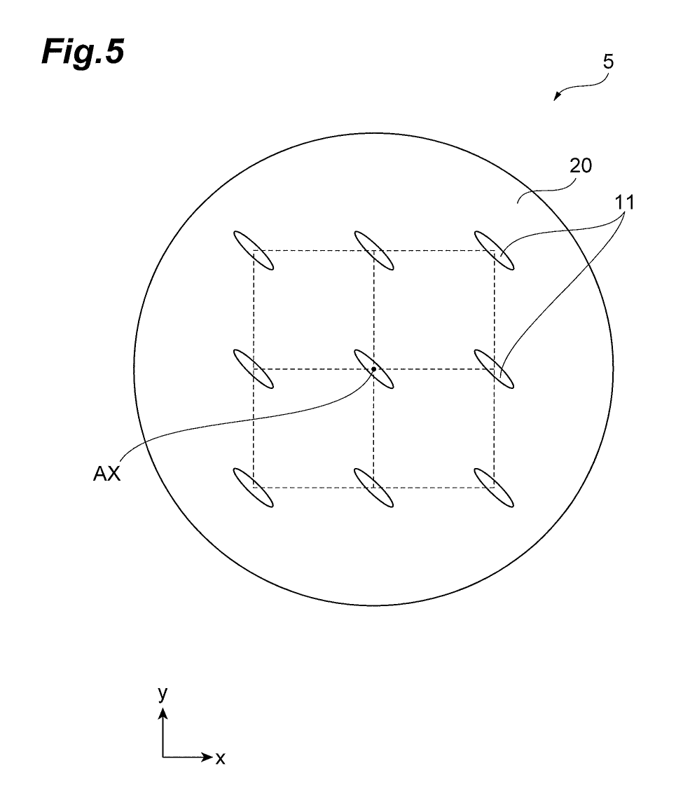

FIG. 5 is a schematic sectional view for showing a configuration of a polarization maintaining multi-core optical fiber according to a fourth embodiment of the present invention.

A polarization maintaining multi-core optical fiber 5 according to the fourth embodiment is one where the arrangement of the elliptic cores 11 which constitutes the polarization maintaining multi-core optical fiber 1 according to the first embodiment has been changed. Specifically, it is one where the centers of nine elliptic cores 11 are arranged so as to correspond to a shape of square lattice points, and in this case, lines connecting between the centers of the nearest cores will be dashed lines as shown in FIG. 5, and straight lines connecting between the centers of the nearest cores extend in the x-axis direction or in the y-axis direction. In this case, as shown in FIG. 5, by making a long axis of the elliptic core 11 directed in the diagonal direction of the square lattice, the direction of the lines (x-axis direction and y-axis direction) connecting between the centers of the nearest cores shown by dashed lines in FIG. 5 and the long axis direction of the field distribution can be made to differ from each other. In this case, an angle between the line connecting between the centers of the nearest cores and the long axis of the field distribution will be 45 degrees.

As the polarization maintaining multi-core optical fiber 5 according to the present embodiment, for example, a diameter of the cladding 20 is made to be 125 μm, the length of the long axis of the elliptic core 11 is made to be 10 μm, the length of the short axis is made to be 2 μm, a relative refractive index difference between a core and a cladding is made to be 1.0%, and a distance between the centers of the nearest cores is made to be 30 μm.

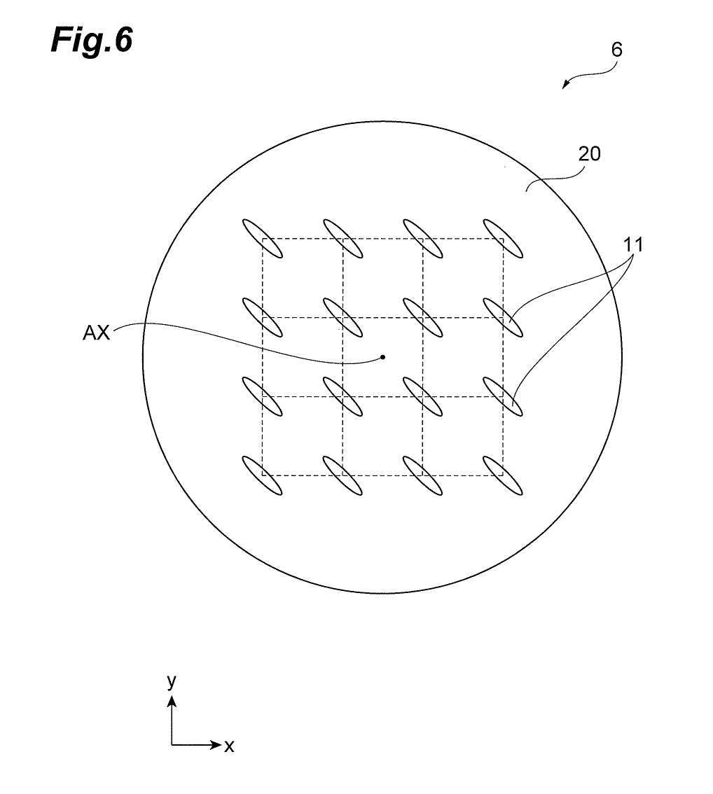

In addition, the number of the elliptic cores included in the polarization maintaining multi-core optical fiber can be changed. In FIG. 6, as a modification example of the fourth embodiment, a polarization maintaining multi-core optical fiber 6 where 16 elliptic cores 11 are arranged is shown. Also in the polarization maintaining multi-core optical fiber 6, the direction of the lines connecting between the centers of the nearest cores is made to be directed in the x-axis direction or in the y-axis direction, and as for the elliptic core 11, an angle between the long axis and the x-axis will be 45 degrees, and the elliptic cores 11 are arranged so that the direction of the lines connecting between the centers of the nearest cores and the long axis direction of the field distribution may differ from each other. As an example of the polarization maintaining multi-core optical fiber 6, when a crosstalk among cores is made to be comparable as the polarization maintaining multi-core optical fiber 5, a diameter of the cladding 20 is made to be 160 μm, the length of the long axis of the elliptic core 11 is made to be 10 μm, the length of the short axis is made to be 2 μm, a relative refractive index difference between a core and a cladding is made to be 1.0%, and a distance between the centers of the nearest cores is made to be 30 μm. Moreover, when giving priority to proximate arrangement of cores (high-density), it is also possible that a diameter of the cladding 20 is made to be 125 μm, the length of the long axis of the elliptic core 11 is made to be 10 μm, the length of the short axis is made to be 2 μm, a relative refractive index difference between a core and a cladding is made to be 1.0%, and a distance between the centers of the nearest cores is made to be 24 μm. In this manner, the polarization maintaining multi-core optical fiber according to the present embodiment is the multi-core optical fiber capable of making the linearly polarized wave propagate with the polarization state maintained, and can exert an effect that cores are arranged with high density and the crosstalk among cores is reduced.

### Fifth Embodiment

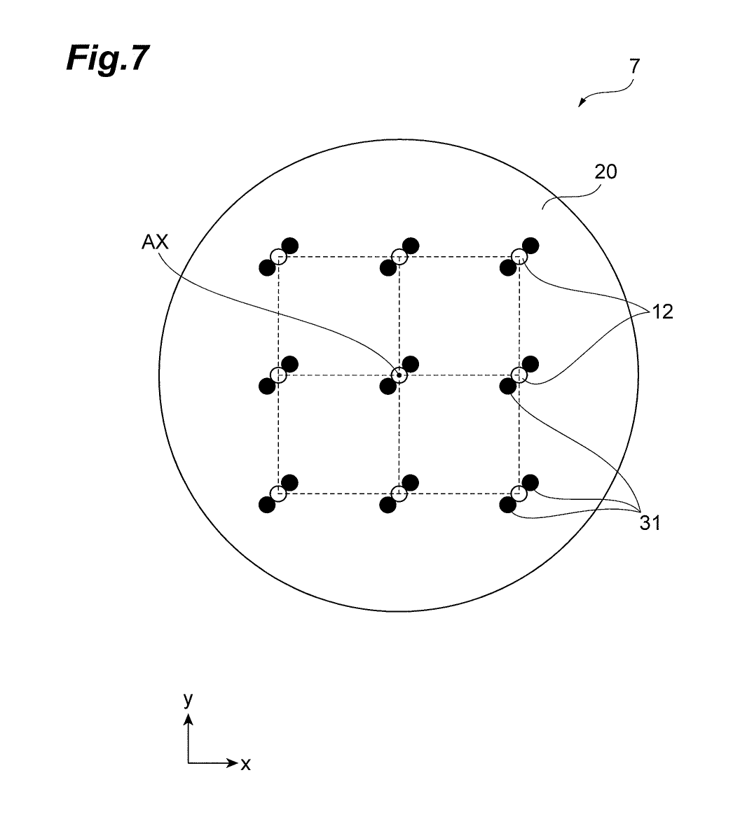

FIG. 7 is a schematic sectional view for showing a configuration of a polarization maintaining multi-core optical fiber according to a fifth embodiment of the present invention.

A polarization maintaining multi-core optical fiber 7 according to the fifth embodiment, in the same way as the polarization maintaining multi-core optical fiber 3 according to the second embodiment, is one where nine circular cores 12 on the side of which the side tunnels 31 are provided are arranged with the centers thereof made to correspond to the square lattice points. In FIG. 7, the lines connecting between the centers of the nearest cores extend in the x-axis direction or the y-axis direction. Then, the side tunnel 31 is provided in the direction of the diagonal line of each lattice in the square lattice. As a result, the direction of the lines connecting between the centers of the nearest cores shown by dashed lines in FIG. 7 and the long axis direction of the field distribution can be made to differ from each other. In this case, an angle between the line connecting between the centers of the nearest cores and the long axis of the field distribution will be 45 degrees.

As the polarization maintaining multi-core optical fiber 7 according to the present embodiment, for example, a diameter of the cladding 20 is made to be 125 μm, a diameter of circular core 12 is made to be 8 μm, a diameter of side tunnel 31 is made to be 10 μm, a center distance between the circular core 12 and the side tunnel 31 is made to be 9 μm, a relative refractive index difference between a core and a cladding is made to be 0.4%, and a distance between the centers of the nearest cores is made to be 30 μm.

### Sixth Embodiment

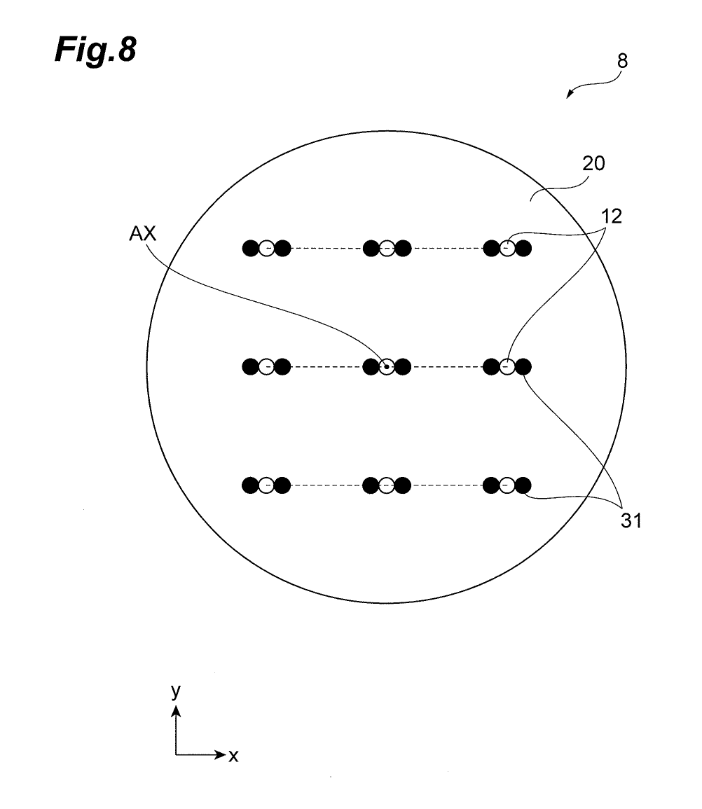

FIG. 8 is a schematic sectional view for showing a configuration of a polarization maintaining multi-core optical fiber according to a sixth embodiment of the present invention.

In the polarization maintaining multi-core optical fiber 7 according to the fifth embodiment, as shown in FIG. 7, the side tunnel 31 has been arranged in the direction of the diagonal line of the square lattice, but when this is made to be arranged in the x-axis direction, the long axis direction of the field distribution is directed in the y-axis direction, and is in agreement with lines extending in the y-axis direction among the dashed lines connecting between the centers of the nearest cores, and as a result, an increase of the crosstalk among cores will be concerned. As a method to solve this, considered is a method where the center distance of cores which are adjacent in the y-axis direction shown in FIG. 7 is made to be enlarged, and these cores are made not to be the nearest cores.

In a polarization maintaining multi-core optical fiber 8 according to the sixth embodiment, an arrangement of nine circular cores 12 on the side of which the side tunnels 31 are provided is made to be changed from the square lattice shape, and is spaced apart in the y-axis direction as compared with FIG. 7. As a result, the lines which are shown with dashed lines and connect between the nearest cores are decreased from 12 (FIG. 7) to six in number, and the circular cores 12 which are adjacent along the y-axis direction are not the nearest cores, and the circular cores 12 which are adjacent along the x-axis direction will be the nearest cores. As a result, even when the side tunnels 31 are arranged in the x-axis direction, it is considered that a crosstalk among cores in the cores located in a line in the y-axis direction is reduced. In the polarization maintaining multi-core optical fiber 8, an angle between the line connecting the centers of the nearest cores and the long axis of the field distribution will be 90 degrees.

As the polarization maintaining multi-core optical fiber 8 according to the present embodiment, for example, a diameter of the cladding 20 is made to be 125 μm, a diameter of the circular core 12 is made to be 8 μm, a diameter of the side tunnel 31 is made to be 10 μm, a center distance between the circular core 12 and the side tunnel 31 is made to be 9 μm, a relative refractive index difference between a core and a cladding is made to be 0.4%, a distance between centers of the nearest cores (center distance between the cores which are adjacent in the x-axis direction) is made to be 25 μm, and a center distance between the centers of the cores which are adjacent in the y-axis direction is made to be 35 μm.

### Seventh Embodiment

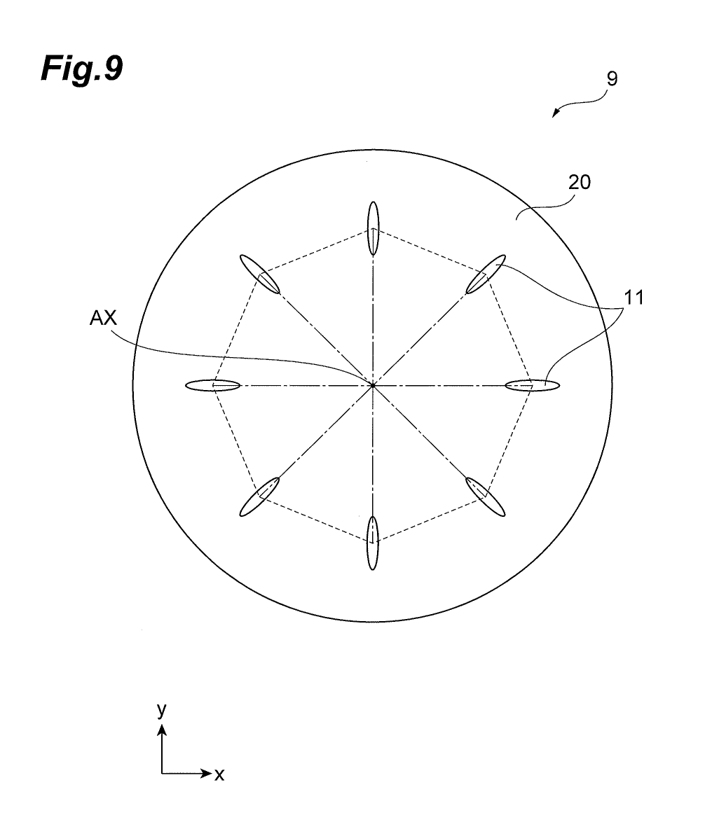

FIG. 9 is a schematic sectional view for showing a configuration of a polarization maintaining multi-core optical fiber according to a seventh embodiment of the present invention.

A polarization maintaining multi-core optical fiber 9 according to the seventh embodiment is one where eight elliptic cores 11 are arranged so that the centers thereof may be located at an equal interval on the same circumference with the center of the cladding 20 as an axis. In the eight elliptic cores 11, included are two cores opposing to each other along the x-axis direction, and two cores opposing to each other along the y-axis direction. In this case, the lines connecting between the centers of the nearest cores will be dashed lines shown in FIG. 9, and will be the lines connecting between the centers of the elliptic cores 11 which are adjacent on the same circumference. In addition, as shown in FIG. 9, by arranging the elliptic cores 11 so that the long axis of the elliptic core 11 may be provided on the line (dashed dotted line in FIG. 9) which connects between the center of the cladding 20 (the center of the circumference on which the centers of the elliptic cores 11 are arranged) and the center of each elliptic core 11, the direction of the lines connecting between the centers of the nearest cores and the long axis direction of the field distribution can be made to differ from each other, and an angle between the direction of the lines connecting between the centers of the nearest cores and the long axis direction of the field distribution will be 67.5 degrees. As a result, overlap of field distributions between the nearest cores is reduced, and the crosstalk among cores is reduced.

As the polarization maintaining multi-core optical fiber 9 according to the present embodiment, for example, a diameter of the cladding 20 is made to be 125 μm, the length of the long axis of the elliptic core 11 is made to be 10 μm, the length of the short axis is made to be 2 μm, a relative refractive index difference between a core and a cladding is made to be 1.0%, and a distance between the centers of the nearest cores is made to be 30 μm.

As described above, embodiments of the present invention have been described, and various modifications can be added to the present invention without being limited to the above-described embodiments. For example, a diameter of the cladding, a size and a shape of the elliptic core 11, and a size and a shape of the circular core 12 can be changed suitably. In addition, the number of the cores included in the polarization maintaining multi-core optical fiber can be also changed suitably.

In accordance with the present invention, it becomes possible to provide a polarization maintaining multi-core optical fiber where high density arrangement of cores and the fiber diameter reduction are accomplished, and a crosstalk among cores is suppressed.

What is claimed is:

1. A polarization maintaining multi-core optical fiber comprising a plurality of cores in the same cladding, the optical fiber having a polarization maintaining characteristic which results from structural asymmetry of each of the plurality of cores or structural asymmetry in vicinity of each of the plurality of cores,
wherein a field distribution of light in each of the plurality of cores is asymmetric, and
wherein a direction of a straight line connecting between a center of an arbitrary core among the plurality of cores and a center of a core nearest to the arbitrary core is different from a long axis direction of the field distribution of light in the arbitrary core.

2. The polarization maintaining multi-core optical fiber according to claim 1, wherein the arbitrary core has a first core diameter along the long axis direction of the field distribution of light in the arbitrary core, and a second core diameter along a short axis direction of the field distribution of light in the arbitrary core, and
wherein the first core diameter and the second core diameter are different from each other.

3. The polarization maintaining multi-core optical fiber according to claim 2, wherein the arbitrary core is an elliptic core.

4. The polarization maintaining multi-core optical fiber according to claim 1, further comprising a pair of holes arranged so as to sandwich the arbitrary core.
